(19) United States
(12) Patent Application Publication
(10) Pub. No.: US 2020/0280871 A1
(43) Pub. Date: Sep. 3, 2020

(54) OPTIMIZATION OF RESOURCE ALLOCATION BASED ON RECEIVED QUALITY OF EXPERIENCE INFORMATION

(71) Applicant: NEC CORPORATION, Tokyo (JP)

(72) Inventors: Chadi KHIRALLAH, Epsom (GB); Yuhua CHEN, London (GB); Alberto SUAREZ, London (GB); Neeraj GUPTA, Sutton, Surrey (GB); Robert ARNOTT, London (GB)

(73) Assignee: NEC CORPORATION, Tokyo (JP)

(21) Appl. No.: 16/650,198

(22) PCT Filed: Sep. 25, 2018
(86) PCT No.: PCT/JP2018/035413

§ 371 Date: Mar. 24, 2020

(30) Foreign Application Priority Data
Sep. 29, 2017 (GB) 1715920.3

(51) Int. Cl. H04W 28/02; H04W 24/10

(52) U.S. Cl. CPC H04W 28/0268; H04W 24/10; H04W 28/0263; H04W 28/0257

(57) ABSTRACT

A method performed by a user equipment in a communication system is disclosed in which the user equipment communicates data with a base station using at least one data radio bearer (DRB). The data is communicated using a plurality of data flows that are mapped to a single DRB. Each data flow is configured to have a respective set of quality of service (QoS) characteristics specific to that data flow. The user equipment measures quality of experience (QoE) parameters for the data flows and reports QoE information to the base station based on the measurement of the QoE parameters.

### TECHNICAL FIELD

The present invention relates to a communication system, to associated apparatus and methods, and particularly but not exclusively to improvements in a quality of service architecture for a cellular communications system. The invention has particular but not exclusive relevance to wireless telecommunications networks implemented according to various standards defined by the 3rd Generation Partnership Project (3GPP).

### BACKGROUND ART

The latest developments of the 3GPP standards are referred to as the Long Term Evolution (LTE) of Evolved Packet Core (EPC) network and Evolved UMTS Terrestrial Radio Access Network (E-UTRAN), also commonly referred to as ‘4G’. In addition, the terms ‘5G’, ‘next generation’ (NG) and ‘new radio’ (NR) refer to an evolving communication technology that is expected to support a variety of applications and services. Various details of 5G networks are described in, for example, the ‘NGMN 5G White Paper’ V1.0 by the Next Generation Mobile Networks (NGMN) Alliance, which document is available from https://www.ngmn.org/5g-white-paper.html. 3GPP intends to support 5G by way of the so-called 3GPP Next Generation (NextGen) radio access network (RAN) and the 3GPP NextGen core network (5GC).

Under the 3GPP standards, a NodeB (or an ‘eNB’ in LTE, ‘gNB’ in 5G) is the base station via which communication devices (user equipment or ‘UE’) connect to a core network and communicate to other communication devices or remote servers. For simplicity, the present application will use the term base station to refer to any such base stations and use the term mobile device or UE to refer to any such communication device. The core network (e.g. the EPC in case of LTE, or 5GC in the case of 5G) hosts functionality for subscriber management, mobility management, charging, security, and call/session management (amongst others), and provides connection for communication devices to external networks, such as the Internet.

Communication devices might be, for example, mobile communication devices such as mobile telephones, smartphones, user equipment (UE), personal digital assistants, laptop/tablet computers, web browsers, e-book readers and/or the like. Such mobile (or even generally stationary) devices are typically operated by a user, although it is also possible to connect so-called ‘Internet of Things’ (IoT) devices and similar machine-type communication (MTC) devices to the network. For simplicity, the present application refers to items of user equipment (UEs) in the description but it will be appreciated that the technology described can be implemented on any communication devices (mobile and/or generally stationary) that can connect to a communications network for sending/receiving data, regardless of whether such communication devices are controlled by human input or software instructions stored in memory.

The Quality of Service (QoS) concept is a well-known concept in communication and computer networking. The term QoS is generally used to refer to the overall performance of a service, such as a data communication service, particularly the performance provided to end users.

For 3GPP LTE networks, the concept of a QoS Class Identifier (QCI) was introduced as a mechanism to facilitate a class-based QoS architecture in which different types of bearer traffic are classified into different classes, each of which represents a respective QoS appropriate for that type of traffic. Each class is identified by a respective QCI. Each QCI is associated with, and acts as a reference to, a set of standardised QoS “characteristics” that are used as a framework for governing how the packet forwarding treatment is applied, edge-to-edge between the UE and the core network, for the traffic of that class in the nodes of the cellular communication network (e.g. in the RAN/base station).

In a typical LTE case in which multiple applications may be running in a UE the base station (eNB for LTE) has, for each enhanced radio access bearer (E-RAB) between the UE and the core network (serving gateway, S-GW), a respective set of QoS parameters (including a QCI, an Allocation and Retention Priority (ARP), and other resource type (e.g. guaranteed bit rate (GBR) resource type or non-GBR resource type) dependent parameters. Accordingly, the QoS provided was at a radio bearer level of granularity.

In 5G, however, the QoS concept has been extended to provide a ‘flow level’ granularity in which different ‘QoS’ data flows via the same radio bearer may each be provided with a different respective QoS. To facilitate this, a new sub-layer (the Service Data Adaptation Protocol (SDAP) layer), that has been introduced above the Packet Data Convergence Protocol (PDCP) layer, manages multiple flows of data (e.g. for different applications). Specifically, in 5G when multiple applications are running in the UE, the base station (gNB for 5G) does not have a respective bearer level QCI (nor an ARP) for each E-RAB between the UE and the core network. Instead, the new SDAP sublayer maps QoS flows to data radio bearers (DRBs) over the radio interface (Uu) between the UE and base station (with one or more QoS flows being mapped to each DRB). A QoS Flow ID (QFI) is used to identify each QoS flow with user plane traffic with the same QoS Characteristics (within a given protocol data unit (PDU) session) receiving the same traffic forwarding treatment (e.g. scheduling, admission threshold). The QFI is carried in an encapsulation header on the ‘N3’ reference point between the RAN and the core network (e.g. a user plane function (UPF) for 5G). The QFI is unique within a given PDU session.

The QCI concept has been extended in 5G with a QCI (referred to as a 5G QoS Indicator (or ‘5QI’)) being associated with each QoS flow (rather than each E-RAB). Like the LTE QCI, the 5G QCI (5QI) is a scalar that is used as a reference to a specific set of QoS characteristics (e.g. access node-specific parameters) that control the QoS forwarding treatment applied (e.g. the applied scheduling weights, admission thresholds, queue management thresholds, link layer protocol configuration, etc.).

In more detail, each QoS flow (GBR and Non-GBR) is associated with a 5QI, an ARP and a number of other flow type dependent QoS parameters. Each GBR QoS flow, for example, is also associated with a Guaranteed Flow Bit Rate (GFBR) for both uplink (UL) and downlink (DL) which denotes the bit rate that may be expected to be provided by the GBR QoS flow. Each GBR QoS flow is also associated with a Maximum Flow Bit Rate (MFBR) for both UL and DL which limits the bit rate that may be expected to be provided by a GBR QoS flow (e.g. if the MFBR is exceeded, excess traffic may get discarded by a rate shaping function). In addition, a GBR QoS flow may be associated with a ‘notification control’ parameter which indicates whether notifications are requested from the RAN when the GFBR can no longer (or again) be fulfilled for a QoS flow during the lifetime of the QoS flow. Each non-GBR QoS flow may, in addition, be associated with a Reflective QoS Attribute (RQA) parameter to indicate that certain traffic on the QoS flow may be subject to reflective QoS.

The QoS characteristics represented by the 5QI can be understood as guidelines for setting node specific parameters for each QoS flow e.g. for 3GPP radio access link layer protocol configurations. The QoS characteristics effectively describe the packet forwarding treatment that a QoS flow should receive edge-to-edge between the UE and the UPF. The QoS characteristics comprise: a resource type (GBR, delay critical GBR, or Non-GBR); a priority level; a packet delay budget (PDB); and packet error rate (PER).

The priority level indicates a priority in scheduling resources among QoS flows. The priority levels are used to differentiate between QoS flows of the same UE, and to differentiate between QoS flows from different UEs. Once all QoS requirements are fulfilled for the GBR QoS flows, spare resources can typically be used for any remaining traffic in an implementation specific manner (unless the priority level for a non-GBR QoS flow has a higher priority than the GBR QoS flows). The lowest priority level value corresponds to the highest priority.

The PDB defines an upper bound for the time that a packet may be delayed between the UE and the UPF that terminates the N6 interface between the UPF and the data network. For a given 5QI, the value of the PDB is the same in uplink and downlink. In the case of 3GPP access, the PDB is used to support the configuration of scheduling and link layer functions. The PDB is interpreted as a maximum delay with a confidence level of 98 percent.

The PER defines an upper bound for the rate of service data units (SDUs—e.g. IP packets) that have been processed by a sender of a link layer protocol (e.g. radio link control (RLC) in RAN of a 3GPP access) but that are not successfully delivered by the corresponding receiver to the upper layer (e.g. PDCP in RAN of a 3GPP access). Thus, the PER defines an upper bound for a rate of non-congestion related packet losses. For a given 5QI the value of the PER is the same in uplink and downlink. For QoS flows with a delay critical GBR resource type, a packet which is delayed more than PDB is counted as lost, and included in the PER.

Currently standardised 5QI values have one-to-one mapping to a standardised combination of 5G QoS characteristics as specified in Error! Reference source not found.

TABLE 1

| | | | Packet | Packet | Default | |
|---|---|---|---|---|---|---|
| 5QI | Resource | Priority | Delay | Error | Averaging | |
| Value | Type | Level | Budget | Rate | Window | Example Services |
| 1 | GBR | 20 | 100 ms | 10⁻² | TBD | Conversational Voice |
| 2 | | 40 | 150 ms | 10⁻³ | TBD | Conversational Video (Live |
| | | | | | | Streaming) |
| 3 | | 30 | 50 ms | 10⁻³ | TBD | Real Time Gaming, V2X |
| | | | | | | messages |
| 4 | | 50 | 300 ms | 10⁻ [symbol] | TBD | Non-Conversational Video |
| | | | | | | (Buffered Streaming) |
| 65 | | 7 | 75 ms | 10⁻² | TBD | Mission Critical user plane |
| | | | | | | Push To Talk voice (e.g., |
| | | | | | | MCPTT) |
| 66 | | 20 | 100 ms | 10⁻³ | TBD | Non-Mission-Critical user |
| | | | | | | plane Push To Talk voice |
| 75 | | 25 | 50 ms | 10⁻³ | TBD | V2X messages |
| 5 | Non-GBR | 10 | 100 ms | 10⁻ [symbol] | N/A | IMS Signalling |
| 6 | | 60 | 300 ms | 10⁻ [symbol] | N/A | Video (Buffered Streaming) |
| | | | | | | TCP-based (e.g., www, e-mail, |
| | | | | | | chat, ftp, p2p file sharing, |
| | | | | | | progressive video, etc.) |
| 7 | | 70 | 100 ms | 10⁻ [symbol] | N/A | Voice, |
| | | | | | | Video (Live Streaming) |
| | | | | | | Interactive Gaming |
| 8 | | 80 | 300 ms | 10⁻ [symbol] | N/A | Video (Buffered Streaming) |
| | | | | | | TCP-based (e.g., www, e-mail, |
| | | | | | | chat, ftp, p2p file |
| 9 | | 90 | | | N/A | sharing, progressive video, |
| | | | | | | etc.) |
| 69 | | 5 | 60 ms | 10⁻ [symbol] | N/A | Mission Critical delay sensitive |
| | | | | | | signalling (e.g., MC-PTT |
| | | | | | | signalling) |
| 70 | | 55 | 200 ms | 10⁻ [symbol] | | Mission Critical Data (e.g. |
| | | | | | | example services are the |
| | | | | | | same as QCI 6/8/9) |
| 79 | | 65 | 50 ms | 10⁻² | N/A | V2X messages |
| | | | | | N/A | |

[symbol]

indicates data missing or illegible when filed

The 5G QoS characteristics may be pre-configured by means of 5QI values pre-configured in the access node. The 5G QoS characteristics may be dynamically assigned by means of 5QI values that are signalled as part of a QoS profile or QoS rule.

According to the QoS architecture for 5G, in a next generation radio access network (NG-RAN) the 5G core network (5GC), may establish one or more PDU sessions for each UE. Within each PDU session, for each UE, the base station may establish one or more DRBs per PDU session. The base station maps packets belonging to different PDU sessions to different DRBs. Hence, the base station establishes at least one default DRB for each PDU session indicated by 5GC upon PDU session establishment. Non-access stratum (NAS) level packet filters in the UE and in the 5GC associate uplink (UL) and downlink (DL) packets with specific QoS Flows. Access Stratum (AS) level mapping in the UE, and in the base station, respectively associate UL and DL QoS Flows with one or more DRBs. The base station and core network ensure quality of service (e.g. reliability and target delay) by mapping packets to appropriate QoS Flows and DRBs. Hence, there is a two-step mapping comprising: mapping IP-flows to QoS flows (NAS); and QoS flows to DRBs (AS). Within each PDU session, is up to the base station how to map multiple QoS flows to a DRB. In the DL, the base station maps QoS Flows to DRBs based on NG-U marking (QoS Flow ID) and the associated QoS profiles. In the UL, the UE marks UL packets sent over the radio interface (Uu) with the QFI for the purposes of marking packets to be forwarded to the core network.

Each QoS flow (GBR and Non-GBR) is associated with a 5QI, an ARP and a number of other flow type dependent QoS parameters.

Each GBR QoS flow, for example, is also associated with a Guaranteed Flow Bit Rate (GFBR) for both UL and DL which denotes the bit rate that may be expected to be provided by the GBR QoS flow. Each GBR QoS flow is also associated with a Maximum Flow Bit Rate (MFBR) for both UL and DL which limits the bit rate that may be expected to be provided by a GBR QoS flow (e.g. if the MFBR is exceeded, excess traffic may get discarded by a rate shaping function). In addition, a GBR QoS flow may be associated with a ‘notification control’ parameter which indicates whether notifications are requested from the RAN when the GFBR can no longer (or again) be fulfilled for a QoS flow during the lifetime of the QoS flow.

### SUMMARY OF INVENTION

The base station may map a GBR flow and a non-GBR flow, or more than one GBR flow to the same DRB. However, in the base station, the packet treatment on the radio interface (Uu) is defined at a DRB level of granularity (i.e. the DRB serves packets with the same packet forwarding treatment). Accordingly, if gNB maps multiple GBR flows, non-GBR flows, or a mix of GBR and non-GBR flows to the same DRB, then all packets of the multiple QoS flows will get the same packet forwarding treatment which may be inefficient and/or inappropriate for some flows.

Moreover, whilst separate DRBs may be established for QoS flows requiring different packet forwarding treatment, thereby ensuring the QoS requirements per QoS flow are met, such a one-to-one mapping may be inefficient in many situations.

Further, if there is any change in QoS flow characteristics (e.g. an increased flow rate), the base station may not be able to meet the associated QoS requirements (e.g. allocate the required PRBs per QoS flow) of all flows sharing the DRB. As a result, the base station may need to drop one or more flows and/or indicate the dropped flow(s) to the core network.

The present invention seeks to provide a communication system and associated apparatus and methods for meeting or at least partially contributing to addressing the above issues.

In one example aspect the invention provides a method performed by a user equipment in a communication system, the method comprising: communicating data with a base station using at least one data radio bearer (DRB), wherein the data is communicated using a plurality of data flows that are mapped to a single DRB, and wherein each of the plurality of data flows is configured to have a respective set of quality of service (QoS) characteristics specific to that data flow; measuring at least one quality of experience (QoE) parameter for the plurality of data flows; and reporting QoE information to the base station based on the measurement of the at least one QoE parameter.

In one example aspect the invention provides a method performed by a base station in a communication system, the method comprising: communicating data with a user equipment (UE) using at least one data radio bearer (DRB), wherein the data is communicated using a plurality of data flows that are mapped to a single DRB, and wherein each of the plurality of data flows is configured to have a respective set of quality of service (QoS) characteristics specific to that data flow; receiving quality of experience (QoE) information to the base station based on the measurement of the at least one quality of experience (QoE) parameter; and performing an action to optimise QoS for the plurality of data flows mapped to a single DRB based on the received QoE information.

In one example aspect the invention provides a method performed by a core network function in a communication system, the method comprising: maintaining quality of service (QoS) information related to a communication session for a user equipment (UE), wherein the communication session is a communication session in which data is communicated via at least one data radio bearer (DRB) between the UE and a base station and using a plurality of data flows that are mapped to a single DRB, and wherein the maintained QoS information respectively comprises, for each data flow mapped to the single DRB, information representing a set of quality of service (QoS) characteristics specific to that data flow; receiving quality of service (QoS) information provided by the base station for at least one data flow for which a QoE experienced at the UE has fallen below a satisfactory level; and performing an action to optimise the maintained QoS information based on the received QoS information.

In one example aspect the invention provides a user equipment (UE) for a communication system, the UE comprising: at least one processor and transceiver, wherein the at least one processor is configured to: control the transceiver to communicate data with a base station using at least one data radio bearer (DRB), wherein the data is communicated using a plurality of data flows that are mapped to a single DRB, and wherein each of the plurality of data flows is configured to have a respective set of quality of service (QoS) characteristics specific to that data flow; measure at least one quality of experience (QoE) parameter for the plurality of data flows; and control the transceiver to report QoE information to the base station based on the measurement of the at least one QoE parameter.

In one example aspect the invention provides a base station for a communication system, the base station comprising: at least one processor and transceiver, wherein the at least one processor is configured to: control the transceiver to communicate data with a user equipment (UE) using at least one data radio bearer (DRB), wherein the data is communicated using a plurality of data flows that are mapped to a single DRB, and wherein each of the plurality of data flows is configured to have a respective set of quality of service (QoS) characteristics specific to that data flow; control the transceiver to receive quality of experience (QoE) information to the base station based on the measurement of the at least one quality of experience (QoE) parameter; and perform an action to optimise QoS for the plurality of data flows mapped to a single DRB based on the received QoE information.

In one example aspect the invention provides a core network function for a communication system, the core network function comprising: at least one processor and transceiver, wherein the at least one processor is configured to: maintain quality of service (QoS) information related to a communication session for a user equipment (UE), wherein the communication session is a communication session in which data is communicated via at least one data radio bearer (DRB) between the UE and a base station and using a plurality of data flows that are mapped to a single DRB, and wherein the maintained QoS information respectively comprises, for each data flow mapped to the single DRB, information representing a set of quality of service (QoS) characteristics specific to that data flow; control the transceiver to receive quality of service (QoS) information provided by the base station for at least one data flow for which a QoE experienced at the UE has fallen below a satisfactory level; and perform an action to optimise the maintained QoS information based on the received QoS information.

In one example aspect the invention provides a communication system comprising a user equipment according to an above mentioned example aspect and a base station according to an above mentioned example aspect. A communication system may further comprise core network function to an above mentioned example aspect.

Example aspects of the invention extend to computer program products such as computer readable storage media having instructions stored thereon which are operable to program a programmable processor to carry out a method as described in the example aspects and possibilities set out above or recited in the claims and/or to program a suitably adapted computer to provide the apparatus recited in any of the claims.

Each feature disclosed in this specification (which term includes the claims) and/or shown in the drawings may be incorporated in the invention independently (or in combination with) any other disclosed and/or illustrated features. In particular but without limitation the features of any of the claims dependent from a particular independent claim may be introduced into that independent claim in any combination or individually.

Although for efficiency of understanding for those of skill in the art, the invention will be described in detail in the context of a 3GPP system (5G networks), the principles of the invention can be applied to other systems.

### BRIEF DESCRIPTION OF DRAWINGS

Example embodiments of the invention will now be described by way of example only with reference to the attached figures in which:

FIG. 1 schematically illustrates a mobile telecommunication system of a type to which the invention is applicable;

FIG. 2 is a simplified schematic illustrating a QoS architecture implemented in the telecommunications system of FIG. 1;

FIG. 3 is a simplified diagram illustrating a user plane protocol stack for the user equipment and base station of the telecommunications system of FIG. 1;

FIG. 4 is a simplified block schematic of the user equipment suitable for use in the telecommunications system of FIG. 1;

FIG. 5 is a simplified block schematic of a base station suitable for use in the telecommunications system of FIG. 1;

FIG. 6 is a simplified block schematic of a core network function suitable for facilitating provision of policy and charging rules functionality in the telecommunications system of FIG. 1;

FIG. 7 is a simplified message sequence diagram illustrating procedures that may be performed between the base station and user equipment of the telecommunications system of FIG. 1;

FIG. 8 is a simplified message sequence diagram illustrating other procedures that may be performed between the base station and user equipment of the telecommunications system of FIG. 1;

FIG. 9 is a simplified message sequence diagram illustrating another procedure that may be performed between the base station and user equipment of the telecommunications system of FIG. 1;

FIG. 10 is a simplified diagram illustrating, per QoS flow, flow control in the base station 5 of the telecommunications system of FIG. 1;

FIG. 11 is a simplified message sequence diagram illustrating another procedure that may be performed between the base station and user equipment of the telecommunications system of FIG. 1;

FIG. 12 is a simplified message sequence diagram illustrating other procedures that may be performed between the base station and user equipment of the telecommunications system of FIG. 1; and

FIG. 13 is a simplified message sequence diagram illustrating a procedure that may be performed between the base station, the user equipment and the core network of the telecommunications system of FIG. 1.

### DESCRIPTION OF EMBODIMENTS

### Overview

FIG. 1 schematically illustrates a cellular telecommunications network 1 in which an item of user equipment (UE) 3 (such as a mobile (cell) telephone or the like) can communicate with another UE via a base station 5 using an appropriate radio access technology (RAT). As those skilled in the art will appreciate, whilst one UE 3 and base station 5 are shown in FIG. 1 for illustration purposes, the system, when implemented, will typically include other base stations and UEs 3. The base station 5 forms part of an associated radio access network (RAN) and operates at least one cell 6 for allowing the UE 3 to access the network and receive one or more associated services.

The base station 5 is configured to operate in accordance with next generation (5G) standards and, in this example, comprises a non-distributed type gNB 5 (although in 5G it may be a distributed base station having a central unit (CU) and one or more plurality of distributed units (DU) each serving at least one associated cell). It will be appreciated that whilst, in this example, a ‘gNB’ type base station is described, it will be appreciated that much of the functionality can be extended to other base stations or similar apparatus for providing radio access to UEs 3.

The base station 5 is connected into the cellular telecommunications network via an associated core network 7 having a plurality of logical core network nodes 7-1, 7-2, 7-3 for supporting communication in the telecommunication system 1. The core network nodes 7 of this example implement, amongst other functions, at least one control plane function (CPF) 7-1, at least one user plane function (UPF) 7-2 and at least one Policy and Charging Rules Function (PCRF). It will be appreciated, however, that the core network 7 will typically include other functions such a mobility management function which provides mobility management functionality (e.g. corresponding to that of an LTE mobility management entity (MME) or the like), etc.

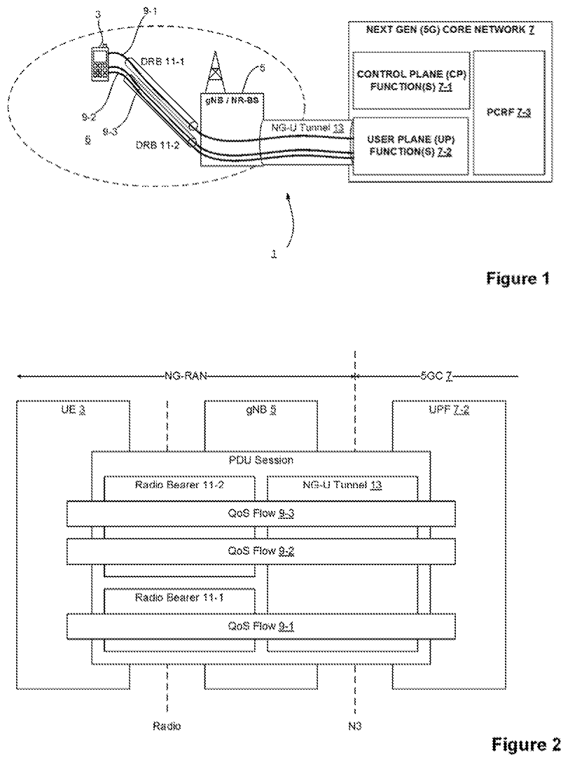

The UE 3, base station 5 and core network functions 7-1, 7-2, 7-3 are configured to implement a QoS architecture in which multiple QoS flows 9 may be mapped to a single data radio bearer (DRB) 11 over the radio interface (Uu) between the UE 3 and the base station 5 and in which QoS is managed at a QoS flow level of granularity as described in general terms in the introduction. The QoS architecture for the cellular telecommunications architecture 1 of FIG. 1 is illustrated in more detail in FIG. 2

As seen in FIG. 2, when a PDU session is established for the UE 3 by the base station 5 of the RAN, one or more DRBs 11-1, 11-2 may be established over the radio interface between the UE 3 and base station 5 as part of that PDU Session.

Non-access stratum (NAS) level packet filters in the UE 3 and in the core network 7 respectively associate uplink (UL) and downlink (DL) packets with a number of different QoS flows 9-1, 9-2, 9-3 between the UE 3 and a UPF 7-2, each QoS flow sharing the same respective QoS Class Identifier (5QI) and hence QoS characteristics. Access stratum (AS) level mapping in the UE 3, and in the base station 5, respectively associate the UL and DL QoS Flows 9 with one or more DRBs 11. Within the PDU session, it is the base station 5 that determines how multiple QoS flows 9 are mapped to corresponding DRBs 11. In the DL, the base station 5 maps QoS flows to DRBs 11 based on NG-U marking (a QoS Flow ID (QFI)) and associated QoS profiles. In the UL, the UE 3 marks UL packets sent over the radio interface (Uu) with the QFI for the purposes of marking packets for appropriate forwarding to the core network.

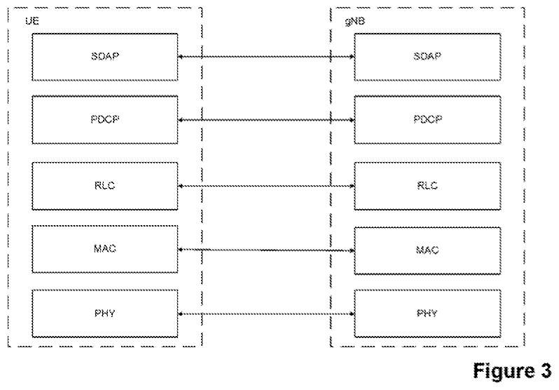

To facilitate the mapping of the QoS flows 9 to DRBs 11 an additional Service Data Adaptation Protocol (SDAP) layer is provided in the user plane (UP) protocol stack for the UE 3 and base station 5. The UP protocol stack is illustrated in FIG. 3. As seen in FIG. 3, the SDAP layer is provided above a Packet Data Convergence Protocol (PDCP) layer, a Radio Link Control (RLC) layer, a Medium Access Control (MAC) and a physical (PHY) layer. The UP protocol stack is described in more detail in 3GPP TS 38.300. The PHY, MAC, RLC and PDCP layers have the usual functionality that those skilled in the art will be familiar with.

The SDAP layer is responsible for mapping the QoS flows 9 to DRBs 11 over the radio interface (Uu) between the UE 3 and base station 5 with one or more QoS flows 9 being mapped to each DRB 11. The SDAP layer is also responsible for marking both DL and UL packets with an appropriate QoS flow ID (QFI) to identify the packets as being part of the corresponding QoS flow 9. The QFI is carried in an encapsulation header on the ‘N3’ reference point between the RAN and the core network 7 (e.g. the UPF 7-2). The QFI for each QoS flow 9 is unique within the PDU session. A single protocol entity of SDAP is configured for each individual PDU session, except for dual connectivity scenarios where two entities may be configured (e.g. one for a master cell group (MCG) and another one for a secondary cell group (SCG)).

In more detail, each QoS flow 9 (which may be a guaranteed bit-rate (GBR) flow, a delay-tolerant GBR flow, or a non-GBR flow) has an associated QoS profile representing the QoS treatment that QoS flow 9 should receive. Specifically, each QoS flow 9 is respectively associated with a QCI/5QI, an Allocation and Retention Priority (ARP) and a number of other flow type dependent QoS parameters. A GBR QoS flow 9, for example, is also associated with a Guaranteed Flow Bit Rate (GFBR) for both UL and DL which denotes the bit rate that may be expected to be provided by the GBR QoS flow 9. Each GBR QoS flow 9 is also associated with a Maximum Flow Bit Rate (MFBR) for both UL and DL which limits the bit rate that may be expected to be provided by a GBR QoS flow 9 (e.g. if the MFBR is exceeded, excess traffic may get discarded by a rate shaping function). In addition, a GBR QoS flow 9 may be associated with a ‘notification control’ parameter which indicates whether notifications are requested from the RAN when the GFBR can no longer (or again) be fulfilled for a QoS 9 flow during the lifetime of the QoS flow 9. Each non-GBR QoS flow 9, in addition, may be associated with a Reflective QoS Attribute (RQA) parameter to indicate that certain traffic on the QoS flow 9 may be subject to reflective QoS.

Policy and Charging Rules Function (PCRF) 7-3 is responsible for maintaining QoS profiles for the QoS flows and for providing QoS setting information for each user session.

The base station 5 monitors the QoS performance for each of the different QoS flows 9 against the QoS characteristics (i.e. the QoS characteristics represented by the QCI/5QI) and QoS parameters configured for that QoS flow. As part of this the base station 5 may measure (or obtain a corresponding measurement results from the UE 3 or other communication entity) appropriate QoS parameters for each flow (for example, the base station might measure any of the parameters included in Table 1: packet delay budget/latency, packet error rate, rate, and priority (in the sense that if any flows cannot meet their requirements it should be the ones with lowest priority)).

Beneficially, in addition to the base station 5 monitoring the QoS performance for each of the different QoS flows 9 against those configured for those flows, the UE 3 monitors the respective Quality of Experience (QoE) experienced by the UE 3 for each QoS flow 9 and reports associated QoE information, to the base station 5, in association with the QFIs to which the QoE information relates. The UE 3 may additionally monitor the QoS performance for each flow, although it will be appreciated that, in this example, QoS parameters are measured at the base station 5 and, hence, reporting of such QoS measurements by the UE 3 may be unnecessary. Nevertheless, there are some scenarios in which it may be beneficial for the UE 3 to report QoS measurements (e.g. when there might be discrepancies between UE 3 and base station 5 measurements).

The QoE measurement might typically involve, for example, QoE parameters directly affecting the user experience, which may be difficult or impossible to derive from QoS parameters. For example, in the case of video streaming services, measured QoE parameters might comprise initial delay (to start of the video) and number and/or duration of re-buffering events (due to buffer underflow) and video jitter. For web-browsing the delay until the web page is rendered in the user device is considered the main QoE metric. On the other hand, QoS parameters (e.g. packet loss), as in Table 1, would measure the network related performance.

Based on the monitoring of the QoS performance by the base station 5 (and possibly the UE 3) and the monitoring by the UE 3 of the QoE actually experienced, the following situations may be identified:
(1) There is no degradation in the monitored QoS for any of the QoS flows 9 beyond acceptable limits; and there is no degradation in the monitored QoE experienced at the UE 3 for any of the QoS flows 9 beyond acceptable limits.
(2) There is degradation in the monitored QoS for at least one QoS flow 9 beyond acceptable limits; but there is no degradation in the monitored QoE experienced at the UE 3 for any of the QoS flows 9 beyond acceptable limits.
(3) There is no degradation in the monitored QoS for any of the QoS flows 9 beyond acceptable limits; but there is degradation in the monitored QoE experienced at the UE 3 for at least one of the QoS flows 9 beyond acceptable limits.
(4) There is degradation in the monitored QoS for at least one QoS flow 9 beyond acceptable limits; and there is degradation in the monitored QoE experienced at the UE 3 for at least one of the QoS flows 9 beyond acceptable limits.

It will be appreciated that, whilst the UE 3 may report the QoE information (and/or any QoS measurement results) regardless of which of the above situations is occurring the UE 3 may only report the QoE information (and/or any QoS measurement results) when the QoE has degraded beyond acceptable limits for one or more QoS flows 9 (e.g. (3) and (4)). If the UE 3 is also aware of the QoS performance, the UE 3 may only report the QoE information and/or QoS measurement results when either the QoE or the QoS have degraded beyond acceptable limits for one or more QoS flows (e.g. (2), (3) and (4)).

In one example, the QoE information provided comprises one or more QoE degradation flags (or similar information element (IE)) that indicate whether or not the QoE being experienced at the UE 3 has degraded beyond an acceptable limit (e.g. a particular trigger level representing the limit of an acceptable QoE has been passed). The QoE flag may comprise, for example, a 1 bit flag set to ‘1’ to indicate QoE degradation and ‘0’ to indicate no degradation (or vice versa). A respective QoE degradation flag may, for example, be provided for every QoS flow 9 (of a given PDU session) that has experienced QoE degradation, in association with that QoS flow's QFI.

Where the UE 3 monitors QoS degradation, a respective QoE degradation flag may (alternatively or additionally) be provided for every QoS flow 9 (of a given PDU session) that has experienced QoS degradation, in association with that QoS flow's QFI. This is particularly beneficial, for example, if the base station 5 determines (from its own QoS monitoring) that the QoS for one or more QoS flows have degraded but the QoE experienced at the UE 3 for the affected flows has, nevertheless, not degraded beyond the trigger level, meaning that the base station 5 does not take action to improve the corresponding QoS unnecessarily.

It will be appreciated that a respective QoE degradation flag may be provided for every QoS flow 9 for a given PDU session, in association with that QoS flow's QFI. Moreover, whilst a per QoS flow QoE degradation flag is particularly useful, a single ‘global’ QoE degradation flag could be used to indicate when QoE degradation is being experienced for one or more QoS flows 9 together with an information element listing the respective QFI of each affected flow.

In another example, the QoE information provided comprises a report of the results of QoE measurements. Such measurement results may, for example, be reported for every QoS flow 9 (of a given PDU session) that has experienced QoE degradation, in association with that QoS flow's QFI and/or may be reported (where the UE 3 monitors for QoS degradation) for every QoS flow 9 (of a given PDU session) that has experienced QoS degradation, in association with that QoS flow's QFI.

In another example, QoE measurement results may be reported for all QoS flows 9 of a given PDU session (i.e. regardless of any degradation), with each measurement report for a particular QoS flow being provided in association with the corresponding QFI. In this example the base station 5 can determine, from the reported measurements, whether or not a given QoS flow 9 is experiencing QoE degradation.

It will be appreciated that for measured QoE parameter reporting, it may be possible to report the QoE parameters, separately, or as part of a combined QoE metric derived from those parameters. For example a Mean Opinion Score (MOS) ranging from 1 to 5 may be considered. In the example in which a single binary QoE degradation flag is reported, a threshold could be applied to the combined QoE metric to determine a case of QoE degradation or not.

In the telecommunication network 1 of FIG. 1, therefore, the base station 5 is able to make advantageous use of reported QoE information reported by the UE 3 to: optimise the QoS parameters for the entire DRB; optimise the resources allocated for all QoS flows on the same DRB; and/or perform appropriate flow control and/or prioritisation (flow shaping) at a QoS flow granularity.

Beneficially, to facilitate flow control over the radio interface at a QoS flow level granularity, the base station 5 is provided with a flow control unit (in the SDAP layer). The flow control unit is configured for performing rate shaping by buffering packets of specific QoS flow(s) (e.g. “offending” flows that are contributing to another flow's degraded QoE) to reduce their rate(s) within a given DRB before the packets of the different QoS flows are passed (and mixed up) in the PDCP layer. Advantageously, therefore, using such flow control, each QoS flow 9 (with a different QoS profile) can receive a different respective packet forwarding treatment, within the same DRB, that is better suited to the specific QoS parameters for that QoS flow 9.

The base station 5 may also make advantageous use of reported QoE information reported by the UE 3 to determine to move the QoE degraded QoS flows 9 to a different existing DRB, or to establish a new DRB and move the QoS flows 9 exhibiting a degraded QoE to the new DRB.

In one example, the base station 5 also beneficially provides QoS information, together with the associated QFIs, to the core network 7 for flows exhibiting a QoE (and/or QoS) that has degraded beyond an acceptable limit. The core network 7 (e.g. the PCRF 7-3) uses the received QoS information to adjust the QoS information/profile for the UE service, for example by adjusting the associated QoS parameters for the affected (or other) QoS flows (e.g. the GFBR and/or MFBR for GBR QoS flows) on the affected DRB(s) to improve UE perceived QoE for the affected flows (e.g. for streaming applications (video stream)).

### UE

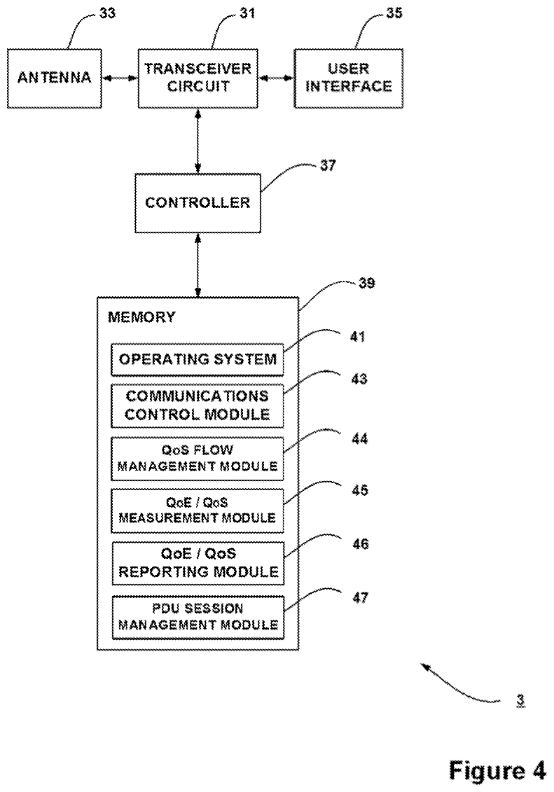

FIG. 4 is a block diagram illustrating the main components of an item of user equipment 3 shown in FIG. 1 (e.g. a mobile telephone or other user equipment).

As shown, the UE 3 has a transceiver circuit 31 that is operable to transmit signals to and to receive signals from a base station 5 via one or more antenna 33. The UE 3 has a controller 37 to control the operation of the UE 3. The controller 37 is associated with a memory 39 and is coupled to the transceiver circuit 31. Although not necessarily required for its operation, the UE 3 might of course have all the usual functionality of a conventional UE 3 (such as a user interface 35) and this may be provided by any one or any combination of hardware, software and firmware, as appropriate. Software may be pre-installed in the memory 39 and/or may be downloaded via the telecommunications network or from a removable data storage device (RMD), for example.

The controller 37 is configured to control overall operation of the UE 3 by, in this example, program instructions or software instructions stored within memory 39. As shown, these software instructions include, among other things, an operating system 41, a communications control module 43, a QoS flow management module 44, a QoE/QoS measurement module 45, a QoE/QoS reporting module 46, and a PDU session management module 47.

The communications control module 43 is operable to control the communication between the UE 3 and its serving base station(s) 5 (and other communication devices connected to the base station 5, such as further UEs and/or core network nodes).

The QoS flow management module 44 is responsible for managing QoS flows at the UE side. The QoS flow management module 44 performs, for example, the SDAP layer functions required to mark UL data packets with appropriate QFIs and to process incoming DL data packets, e.g. from the PDCP layer, at the QoS flow level.

The QoE/QoS measurement module 45 performs appropriate QoE measurements for assessing whether the QoE for each QoS flow has degraded beyond acceptable limits. The QoE may, for example, be assessed against one or more predefined thresholds, which delineate the acceptable degradation limit, and that are stored in memory 39. For example, where a particular measurement result that increases with QoE, falls below a corresponding threshold, or a measurement result that decreases with QoE rises above a threshold, the QoE may be deemed to have degraded beyond acceptable limits. It will be appreciated, however, that the QoE may not be deemed to have degraded until a predefined set of such thresholds has been passed in a manner indicative of QoE degradation. Where the UE 3 performs QoS measurements, the QoE/QoS measurement module 45 also performs these measurements for assessing whether the QoS for each QoS flow has degraded beyond acceptable limits (e.g. based on one or more predefined thresholds for the QoS measurements as described for QoE degradation based, for example, on the configured QoS characteristics and/or other QoS parameters in the QoS profile).

The QoE/QoS reporting module 46 is responsible for performing the reporting of QoE information such as a QoE degradation flag (if such a flag is used) and/or other QoE information (e.g. QoE measurement results). The reporting may be done periodically, may be event triggered, or may be performed at the request of the base station 5.

The PDU session management module 47 controls the UE's part in the setup, maintenance and termination of PDU sessions.

### Base Station

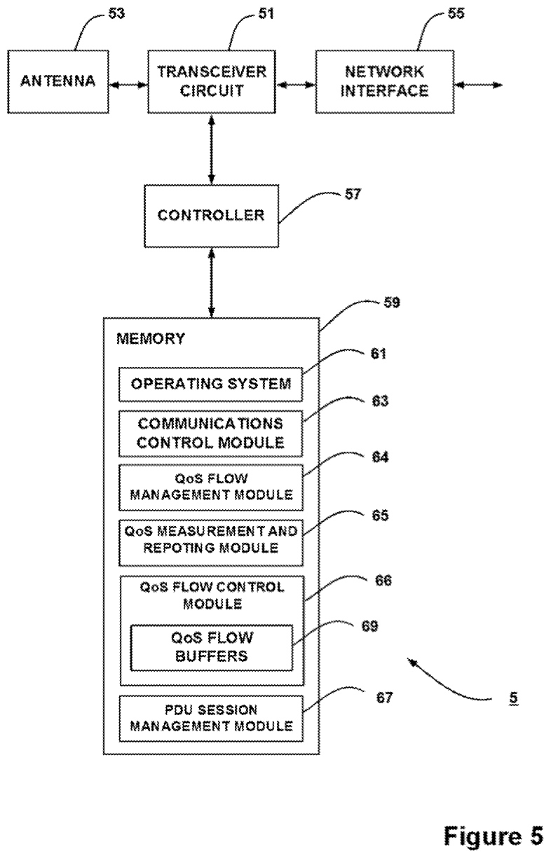

FIG. 5 is a block diagram illustrating the main components of a base station 5 as shown in FIG. 1. As shown, the base station 5 has a transceiver circuit 51 for transmitting signals to and for receiving signals from the UEs 3 via one or more antenna 53 (e.g. an antenna array/massive antenna), and a network interface 55 for transmitting signals to and for receiving signals from network nodes (e.g. other base stations and/or nodes in the core network 7).

The base station 5 has a controller 57 to control the operation of the base station 5. The controller 57 is associated with a memory 59. Software may be pre-installed in the memory 59 and/or may be downloaded via the communications network 1 or from a removable data storage device (RMD), for example. The controller 57 is configured to control the overall operation of the base station 5 by, in this example, program instructions or software instructions stored within memory 59. As shown, these software instructions include, among other things, an operating system 61, a communications control module 63, a QoS flow management module 64, a QoS measurement and reporting module 65, a QoS flow control module 66, and a PDU session management module 67.

The communications control module 63 is operable to control the communication between the base station 5 and UEs 3 and other network entities that are connected to the base station 5. The communications control module 63 also controls the separate flows of downlink user traffic (via associated data radio bearers) and control data to be transmitted to communication devices associated with this base station 5 including, for example, control data for core network services and/or mobility of the UE 3 (also including general (non-UE specific) system information and reference signals).

The QoS flow management module 64 is responsible for managing QoS flows at the base station side including the mapping of QoS flows to appropriate DRBs. The QoS flow management module 64 performs, for example, the SDAP layer functions required to mark DL data packets with appropriate QFIs and to process incoming UL data packets, e.g. from the PDCP layer, at the QoS flow level.

The QoS measurement and reporting module 65 performs appropriate QoS measurements for assessing whether the QoS performance for each QoS flow has degraded beyond acceptable limits. The QoS performance may, for example, be assessed against the configured QoS characteristics and/or other QoS parameters in the QoS profile (e.g. based on one or more predefined thresholds for the QoS measurements similar to the thresholds described for QoE degradation above).

The QoS measurement and reporting module 65 is also responsible for reporting of QoS information such as a QoS measurement results or the like to the core network 7 (e.g. ultimately to the PCRF 7-3). It will be appreciated that the reported QoS information may comprise the result of QoS measurements performed by the base station 5 and/or QoS information received from the UE 3.

The QoS flow control module 66 is responsible for performing QoS flow based flow control at a QoS flow level granularity. The QoS flow control module 66 is configured for performing rate shaping by buffering packets of specific QoS flow(s) in associated QoS flow buffers 69 to reduce their rate(s) within a given DRB (e.g. to reduce the data rate of “offending” flows that are contributing to another QoS flow's degraded QoE) before the packets of the different QoS flows are passed (and mixed up) in the PDCP layer.

The PDU session management module 67 controls the base station's part in the setup, maintenance and termination of PDU sessions including the setup, maintenance and management of appropriate DRBs.

### PCRF

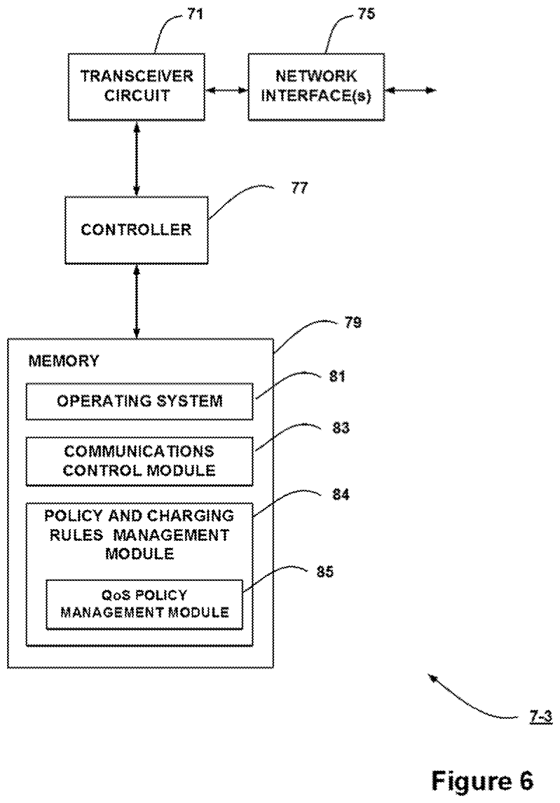

FIG. 6 is a block diagram illustrating the main components of a core node 7-3 that provides a policy charging and rules function 7-3 (PCRF). The core node 7-3 comprises transceiver circuitry 71 which is operable to transmit signals to and to receive signals from the base station 5 and/or other nodes (e.g. other core nodes providing other core network functions) via a network interface 75. A controller 77 controls the operation of the transceiver circuitry 71 in accordance with software stored in memory 79. The software includes, among other things, an operating system 81, a communications control module 83, and a policy and charging rules module 84.

The communications control module 83 is operable to control direct and/or indirect communication between the core node 7-3 and other network entities (e.g. the base station 5 and/or other core nodes providing other core network functions) that are connected (directly or indirectly) to the core node 7-3.

The policy and charging rules management module 84 is responsible for managing the core network function to provide the policy and charging rules functionality to supports service data flow detection, policy enforcement and flow-based charging (e.g. the accumulation of data usage statistics, from multiple base stations). The policy and charging rules management module 84 comprises a QoS policy management module 85 for managing the QoS policy and providing, to the base station 5, appropriate QoS setting information for each QoS flow in a PDU session. The QoS policy management module 85 is able to add and re-configure policies to dynamically manage and control Quality of Service (QoS) appropriately.

In the above description, the UE 3, base station 5 and core network function are described for ease of understanding as having a number of discrete modules (such as the communications control modules and the beam configuration/control modules). Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities. These modules may also be implemented in software, hardware, firmware or a mix of these.

A number of procedures will now be described, by way of example only, which may be implemented to help provide efficient QoS management at a QoS flow level of granularity having a number of benefits. It will be appreciated that whilst each of these procedures may provide technical benefits independently when implemented in isolation, any combination of these procedures may be implemented together where appropriate.

### QoE Reporting

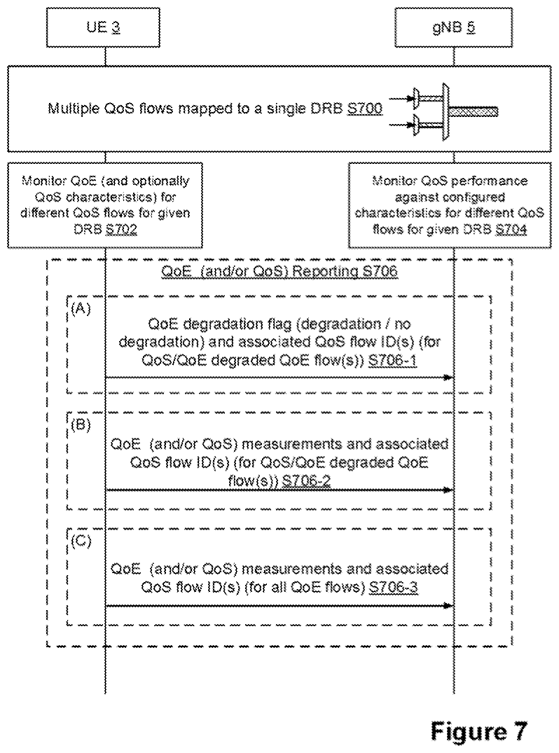

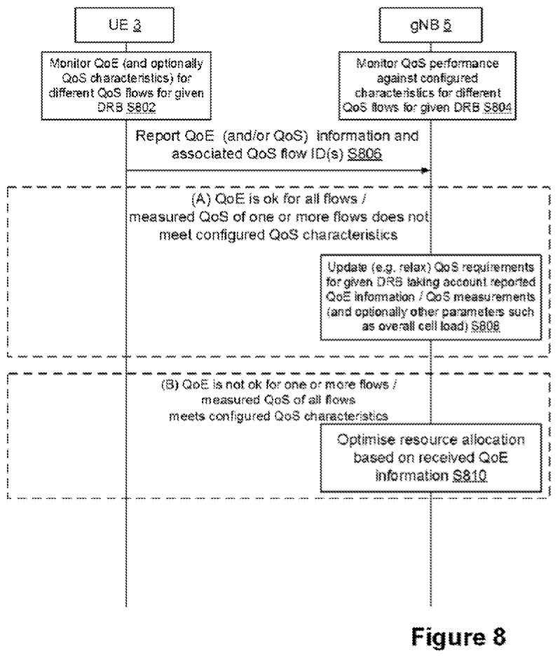

FIG. 7 is a simplified message sequence diagram illustrating a procedure, that may be performed between the base station 5 and user equipment 3 of the telecommunications system of FIG. 1, for acquiring information at the base station 5 for the purposes of assessing the QoE and QoS of each of a plurality of QoS flows that are provided via a single DRB within a given PDU session and identifying actions that may be performed to ensure an acceptable QoE is provided across all QoS flows whilst optimising the QoS for each of those flows.

As seen in FIG. 7, at S700, a plurality of QoS flows are mapped to a single DRB in a particular PDU session (although there may be other DRBs within the same PDU session each associated with one or more respective QoS flows).

At S702, the QoE experienced at the UE 3 for each of the plurality of QoS flows is respectively monitored by making appropriate measurements. The UE 3 may also monitor QoS characteristics for each QoS flow if necessary. At S704 the base station 5 monitors QoS performance for each of the QoS flows against the configured QoS characteristics for those flows. The UE 3 reports, at S706, QoE information acquired by the UE 3 as a result of the monitoring at S702.

The UE 3 may report the acquired QoE information in a number of different ways as illustrated in options (A) to (C) in FIG. 7. It will be appreciated that these options are not necessarily mutually exclusive and may be provided as alternative reporting options that may be selected for a particular UE 3 depending on circumstances.

In FIG. 7(A) the UE 3 reports, at S706-1, acquired QoE information comprising one or more QoE degradation flags (or similar information element (IE)) to indicate whether or not the QoE being experienced at the UE 3 has degraded beyond an acceptable limit (e.g. based on an assessment of QoE measurements against one or more thresholds as described above). In this example a respective QoE degradation flag is provided for every QoS flow 9 (of a given PDU session) that has experienced QoE degradation, in association with that QoS flow's QFI.

Where the UE 3 monitors QoS degradation, a respective QoE degradation flag may also be provided for every QoS flow 9 (of a given PDU session) that has experienced QoS degradation, in association with that QoS flow's QFI, even if that flow is not currently experiencing unacceptable QoE degradation. Accordingly, if the base station 5 determines (from its own QoS monitoring) that the QoS for one or more QoS flows has degraded but the QoE experienced at the UE 3 for the affected flows has, nevertheless, not degraded unacceptably, then the base station 5 does not need to take action to improve the corresponding QoS unnecessarily (or can take action to relax the associated QoS requirements).

In FIG. 7(B), the QoE information provided comprises a report of the results of QoE measurements. Such measurement results are, in this example, reported for every QoS flow 9 (of a given PDU session) that has experienced QoE degradation, in association with that QoS flow's QFI. Similarly, a report of the results of QoE measurements may be provided for every QoS flow 9 (of a given PDU session) that has experienced QoS degradation, in association with that QoS flow's QFI (where the UE 3 monitors for QoS degradation).

In FIG. 7(C), QoE measurement results may be reported for all QoS flows 9 of a given PDU session (i.e. regardless of any QoE degradation), with each measurement report for a particular QoS flow being provided in association with the corresponding QFI. In this example the base station 5 can thus determine, from the reported measurements, not only whether or not any specific QoS flow 9 is exhibiting QoE degradation but also the extent to which that QoS flow 9 is exhibiting QoE degradation. Accordingly, the base station 5 can not only establish whether the QoE experienced at the UE 3 for a given flow is (or is not) acceptable but can also determine the extent to which the QoE is exceeding acceptable limits (or falling below them). The base station 5 can thus take more informed action to optimise the various QoS requirements/resource allocations for the different QoS flows (e.g. to bring QoE for all QoS flows as close to acceptable limits as possible).

One or more of these reporting options may thus be used to provide the base station 5 with information that enables the base station 5 to: optimise the QoS parameters for the entire DRB; optimise the resources allocated for all QoS flows on the same DRB; and/or perform appropriate flow control and/or prioritisation (flow shaping) at a QoS flow granularity.

A number of procedures will now be described, by way of example only, to illustrate how the base station may use the QoE information received from the UE 3 to help provide efficient QoS management at a QoS flow level of granularity having a number of benefits.

### Use of QoE Information

As explained above, the following situations may be arise depending on the QoE experienced at the UE for each QoS flow and the QoS performance exhibited by each QoS flow when compared to the configured QoS characteristics:
(1) There is no degradation in the monitored QoS for any of the QoS flows beyond acceptable limits; and there is no degradation in the monitored QoE experienced at the UE 3 for any of the QoS flows beyond acceptable limits.
(2) There is degradation in the monitored QoS for at least one QoS flow beyond acceptable limits; but there is no degradation in the monitored QoE experienced at the UE 3 for any of the QoS flows beyond acceptable limits.
(3) There is no degradation in the monitored QoS for any of the QoS flows beyond acceptable limits; but there is degradation in the monitored QoE experienced at the UE 3 for at least one of the QoS flows beyond acceptable limits.
(4) There is degradation in the monitored QoS for at least one QoS flow beyond acceptable limits; and there is degradation in the monitored QoE experienced at the UE 3 for at least one of the QoS flows beyond acceptable limits.

FIGS. 8 to 11 each illustrates how the base station 5 may beneficially use acquired QoE/QoS information in one or more of the above situations although it will be appreciated that the base station may also use the acquired QoE/QoS information, in a similar way, in a different one of the situations if appropriate.

FIG. 8, for example, is a message sequence diagram illustrating how the base station 5 may use acquired QoE/QoS information in the context of situations (2) and (3).

In FIG. 8, at S802, the QoE experienced at the UE 3 for each of the plurality of QoS flows is respectively monitored by making appropriate measurements. The UE 3 may also monitor QoS characteristics for each QoS flow if necessary. At S804 the base station 5 monitors QoS performance for each of the QoS flows against the configured QoS characteristics for those flows. The UE 3 reports, at S806, QoE information acquired by the UE 3 as a result of the monitoring at S802 (e.g. as described with reference to one of FIGS. 7(A) to (C).

In FIG. 8(A) the QoE information reported by the UE 3 and the QoS information acquired by the base station 5 (either from its own QoS measurements or from QoS measurement results reported by the UE 3) indicate that there is degradation in the monitored QoS for at least one QoS flow beyond acceptable limits, but there is no degradation in the monitored QoE experienced at the UE 3 beyond acceptable limits for any of the QoS flows.

This indicates that it may be possible to achieve a satisfactory QoE at the UE 3, for all QoS flows, with less stringent QoS requirements. Accordingly, at S808, the base station 5 update the QoS parameters (e.g. to relax the QoS requirements) for a given DRB, based on the reported QoE information (and possibly one or other parameters such as overall cell load) whilst still ensuring that an acceptable QoE is maintained for all QoS flows on that DRB at the UE 3. Where the actual QoE measurements are reported (as opposed to simply a QoE degradation flag), as described with reference to FIGS. 7(B) and (C), the extent to which the measured QoE exceeds a target level may beneficially be used to inform the base station's decision on whether or not to update the QoS parameters of the DRB and, if the QoS parameters are to be updated, the extent to which they can be updated without causing an unacceptable degradation in QoE.

In FIG. 8(B) the QoE information reported by the UE 3 and the QoS information acquired by the base station 5 (either from its own QoS measurements or from QoS measurement results reported by the UE 3) indicate that there is no degradation in the monitored QoS for any of the QoS flows beyond acceptable limits, but there is degradation in the monitored QoE experienced at the UE 3 for at least one of the QoS flows beyond acceptable limits.

This indicates that it is not possible to achieve a satisfactory QoE at the UE 3, for all QoS flows, with the current resources allocated for the DRB and with the current way the resources are shared between QoS flows. Accordingly, at S810, the base station 5 optimises the resource allocation for a given DRB, based on the reported QoE information to ensuring that an acceptable QoE is reached for all QoS flows on that DRB at the UE 3. Where the actual QoE measurements are reported (as opposed to simply a QoE degradation flag), as described with reference to FIGS. 7(B) and (C), the extent to which the measured QoE exceeds a target level may beneficially be used to inform the base station's decision on how to optimise the resources. The base station 5 may achieve this optimisation by assigning sufficient additional resources to the DRB (e.g. updating the QoS requirements to be more stringent) and/or by changing the QoS flow to DRB mapping. For example, the base station may remap one or more QoS flows exhibiting an unacceptably degraded QoE to a different DRB with more stringent QoS requirements whilst the QoS flows exhibiting an acceptable QoE could be kept mapped to the existing DRB.

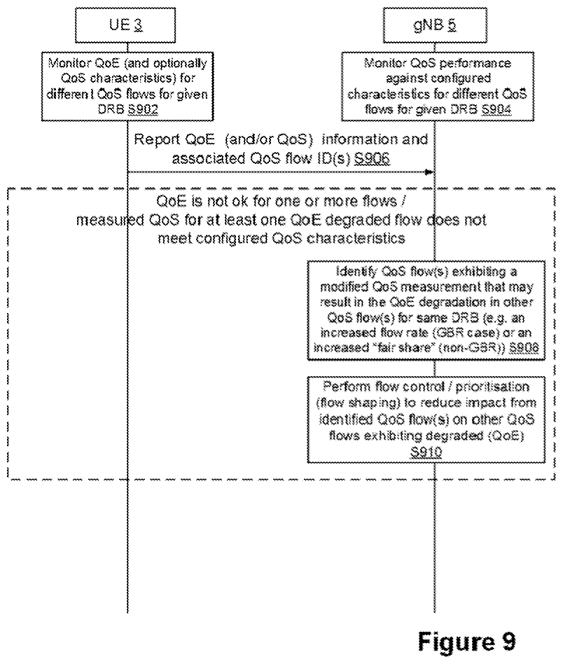

FIG. 9, is a message sequence diagram illustrating how the base station 5 may use acquired QoE/QoS information in the context of situation (4).

In FIG. 9, at S902, the QoE experienced at the UE 3 for each of the plurality of QoS flows is respectively monitored by making appropriate measurements. The UE 3 may also monitor QoS characteristics for each QoS flow if necessary. At S904 the base station 5 monitors QoS performance for each of the QoS flows against the configured QoS characteristics for those flows. The UE 3 reports, at S906, QoE information acquired by the UE 3 as a result of the monitoring at S902 (e.g. as described with reference to one of FIGS. 7(A) to (C).

In FIG. 9 the QoE information reported by the UE 3 and the QoS information acquired by the base station 5 (either from its own QoS measurements or from QoS measurement results reported by the UE 3) indicate that there is degradation in the monitored QoE experienced at the UE 3 for at least one of the QoS flows beyond acceptable limits and there is degradation in the monitored QoS beyond acceptable limits for at least one QoS flow that is experiencing the QoE degradation beyond acceptable limits.

In this situation one or more QoS flows with an acceptable QoE may be exhibiting a modified QoS performance (e.g. an excess incoming rate) that is better than the characteristics configured for them in their respective QoE profiles. The improved QoS performance of these QoS flows compared to other QoS flows may have resulted in the QoE degradation (and/or QoS degradation for other flows). Accordingly, at S908, the base station 5 identifies any “offending” QoS flows that exhibit an acceptable QoE and a modified QoS performance, that is better than the characteristics configured in their respective QoE profiles (e.g. GBR QoS flows exhibiting an increased data rate over the rate configured in the QoS profile or non-GBR QoS flows with an increased “fair share” of resources over).

At S910, the base station 5 then performs flow control/prioritisation (flow shaping) to reduce impact from identified “offending” QoS flow(s) on other QoS flows exhibiting degraded (QoE).

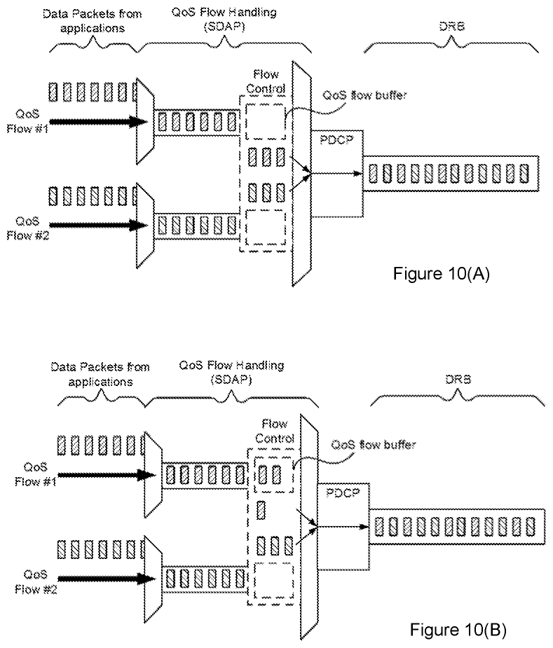

FIG. 10 illustrates how such flow control may be performed, at a QoS flow granularity, in the base station 5. As seen in FIG. 10, flow control may be applied in the SDAP layer (e.g. by the QoS flow control module of FIG. 5) by means of one or more QoS buffers. Referring to FIG. 10(A), in this example, no flow control is applied to flows (i.e. QoS flow #1 or QoS flow #2) that share the same DRB, the flows effectively receive the same packet forwarding treatment. Referring to FIG. 10(B), in this example, flow control is applied to one of flows that shares the DRB (i.e. QoS flow #1), to restrict the packets forwarded to the PDCP layer, by buffering some of the packets of the QoS flow being controlled in a QoS flow buffer. The other (i.e. QoS flow #2) is not subject to flow control.

In this way, therefore, the base station 5 can perform ‘per QoS flow’ rate shaping by buffering packets of specific QoS flow(s) (e.g. “offending” flows) to reduce their rate(s) in the DRB (before the packets of different QoS flows are mapped to DRBs and forwarded to and hence mixed up in the PDCP and lower layers). Using such flow control different QoS flows (with different QoS profiles) can, therefore, beneficially receive different packet forwarding treatments, in the same DRB, that are more suited to their QoS parameters.

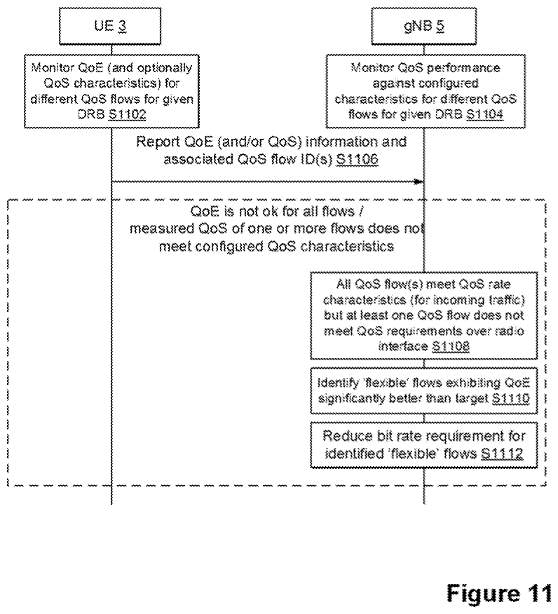

FIG. 11, is a message sequence diagram illustrating another example of how the base station 5 may use acquired QoE/QoS information in the context of situation (4).

In FIG. 11, at S1102, the QoE experienced at the UE 3 for each of the plurality of QoS flows is respectively monitored by making appropriate measurements. The UE 3 may also monitor QoS characteristics for each QoS flow if necessary. At S1104 the base station 5 monitors QoS performance for each of the QoS flows against the configured QoS characteristics for those flows. The UE 3 reports, at S1106, QoE information acquired by the UE 3 as a result of the monitoring at S1102 (e.g. as described with reference to one of FIGS. 7(A) to (C).

In FIG. 11 the QoE information reported by the UE 3 and the QoS information acquired by the base station 5 (either from its own QoS measurements or from QoS measurement results reported by the UE 3) indicate that there is degradation in the monitored QoS for at least one QoS flow beyond acceptable limits and there is degradation in the monitored QoE experienced at the UE 3 for at least one of the QoS flows beyond acceptable limits.

However, in the Example of FIG. 11, the base station 5 determines, at S1108, that even though one or more of the flows does not meet the QoS requirements over the radio interface (e.g. due to the data rate, latency or some other measured QoS parameter) all the QoS flows meet QoS rate characteristics for incoming traffic.

In order to address this issue, the base station 5 identifies at S1110, based on the QoE information reported by the UE 3, ‘flexible’ QoS flows that may be able to achieve a satisfactory QoE even with a lower bit-rate. The ‘flexible’ flows may be determined by adjusting the QoS flow characteristics for each QoS flow exhibiting a sufficiently high QoE and monitoring feedback from the UE 3. Alternatively, the ‘flexible’ flows may be identified implicitly to be QoS flows for which the UE reports QoE measurements significantly above target.

At S1112 the base station 5, reduces the bit rate requirement for the identified ‘flexible’ QoS flows thereby freeing up resource for other QoS flows that are exhibiting an unacceptable QoE. In this way therefore it may be possible to fulfil the QoE targets for all QoS flows mapped to a particular DRB and thereby increase the overall user satisfaction.

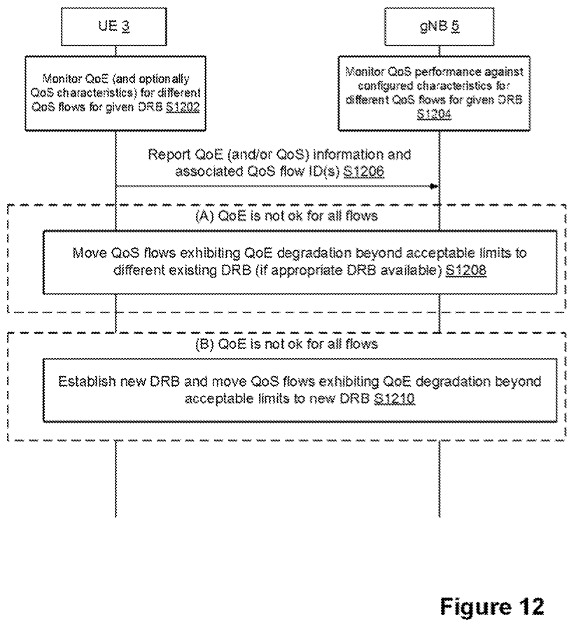

FIG. 12, is a message sequence diagram illustrating another example of how the base station 5 may use acquired QoE/QoS information in situations in which unacceptable QoE degradation is experienced for one or more QoS flows.

In FIG. 12, at S1202, the QoE experienced at the UE 3 for each of the plurality of QoS flows is respectively monitored by making appropriate measurements. The UE 3 may also monitor QoS characteristics for each QoS flow if necessary. At S1204 the base station 5 monitors QoS performance for each of the QoS flows against the configured QoS characteristics for those flows. The UE 3 reports, at S1206, QoE information acquired by the UE 3 as a result of the monitoring at S1202 (e.g. as described with reference to one of FIGS. 7(A) to (C).

In this example, the base station off-loads QoS flows exhibiting unacceptably degraded QoE to another DRB. Specifically, in FIG. 12(A) the base station 5 off-loads, at S1208, one or more QoE degraded QoS flows by re-mapping the affected QoS flow(s) to another existing DRB (e.g. one having more stringent QoS requirements). In FIG. 12(B) the base station 5 odd-loads, at S1210, one or more QoE degraded QoS flows by establishing one or more new DRBs and re-mapping the affected QoS flow(s) to the new DRB(s).

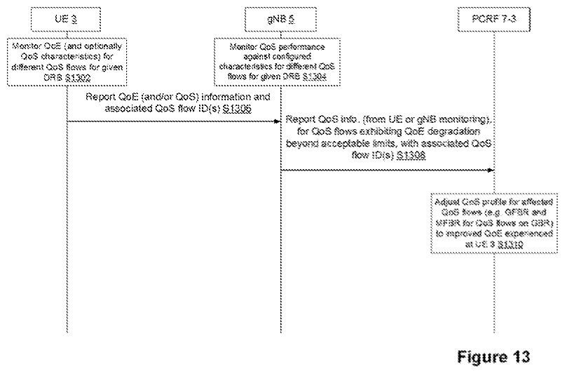

FIG. 13, is a message sequence diagram illustrating another example of how the base station 5 may use acquired QoE/QoS information.

In FIG. 13, at S1302, the QoE experienced at the UE 3 for each of the plurality of QoS flows is respectively monitored by making appropriate measurements. The UE 3 may also monitor QoS characteristics for each QoS flow if necessary. At S1304 the base station 5 monitors QoS performance for each of the QoS flows against the configured QoS characteristics for those flows. The UE 3 reports, at S1306, QoE information acquired by the UE 3 as a result of the monitoring at S1302 (e.g. as described with reference to one of FIGS. 7(A) to (C).

In this example, the base station 5 provides, at S1308, the QoS information for the QoS flow(s) exhibiting an unacceptably degraded QoE, in association with the corresponding QFI(s), to the core network 7. The PCRF 7-3 in the core network 7 receives this information and adjusts, at S1310, the QoS profile for the UE service(s) corresponding for the affected QoS flow(s) to improve the perceived QoE at the UE 3. For example the PCRF may adjust the GFBR and MFBR, for GBR QoS flows, to improve the UE perceived QoE for streaming applications (e.g. video streaming).

### Modifications and Alternatives

A number of detailed example embodiments have been described above. As those skilled in the art will appreciate, a number of modifications and alternatives can be made to the above example embodiments whilst still benefiting from the inventions embodied therein. By way of illustration only a number of these alternatives and modifications will now be described.

In the above example embodiments, a number of software modules were described for implementing the user equipment, base stations and/or core network functions and the like. As those skilled will appreciate, such software modules may be provided in compiled or un-compiled form and may be supplied to the corresponding hardware as a signal over a computer network, or on a recording medium. Further, the functionality performed by part or all of this software may be performed using one or more dedicated hardware circuits. However, the use of software modules is preferred as it facilitates the updating of the corresponding hardware in order to update its functionality. Similarly, although the above example embodiments employed transceiver circuitry, at least some of the functionality of the transceiver circuitry can be performed by software.

The functionality of the user equipment and base stations (gNBs) and core network nodes may be implemented using one or computer processing apparatus having one or more hardware computer processors programmed using appropriate software instructions to provide the required functionality (e.g. one or more computer processors forming part of the controllers described with reference to FIGS. 4 to 6). It will be further appreciated that all or part of this functionality may be implemented in hardware as dedicated circuitry for example using one or more dedicated integrated circuits such as an application specific integrated circuit (ASIC) or the like.

It will be appreciated that the controllers referred to in the description of the UE, gNBs and core network nodes/functions may comprise any suitable controller such as, for example an analogue or digital controller. Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In one in an example described above a method is performed by a user equipment in a communication system, the method comprising: communicating data with a base station using at least one data radio bearer (DRB), wherein the data is communicated using a plurality of data flows that are mapped to a single DRB, and wherein each of the plurality of data flows is configured to have a respective set of quality of service (QoS) characteristics specific to that data flow; measuring at least one quality of experience (QoE) parameter for the plurality of data flows; and reporting QoE information to the base station based on the measurement of the at least one QoE parameter.

The measuring may comprise respectively measuring the at least one QoE parameter for each of the plurality of data flows mapped to the single DRB.

The reported QoE information may comprise data flow specific QoE information for at least one of the plurality of data flows that are mapped to the single DRB, and the reporting may comprise reporting the data flow specific QoE information in association with information identifying the data flow (e.g. a QoS flow identifier, QFI) to which the data flow specific QoE information relates.

The method may further comprise determining whether or not QoE has fallen below a satisfactory level for at least one data flow.

The reported QoE information may comprise at least one information element for indicating whether or not QoE has fallen below a satisfactory level for at least one data flow (e.g. at least one QoE flag). The at least one information element for indicating whether or not QoE has fallen below a satisfactory level may comprise a respective said information element for each data flow for which QoE has fallen below a satisfactory level. The at least one information element for indicating whether or not QoE has fallen below a satisfactory level may comprise a respective said information element for every data flow mapped to the single DRB.

The reported QoE information may comprise results acquired by the measuring of the at least one QoE parameter. The reported results acquired by the measuring of the at least one QoE parameter may comprise respective said results for each data flow for which QoE has fallen below a satisfactory level. The reported results acquired by the measuring of the at least one QoE parameter may comprise respective said results for every data flow mapped to the single DRB.

The method may further comprise measuring at least one QoS parameter for at least one of the plurality of data flows mapped to the single DRB.

The reporting may further comprise reporting QoS information to the base station based on the measurement of the at least one QoS parameter.

In another example described above a method is performed by a base station in a communication system, the method comprising: communicating data with a user equipment (UE) using at least one data radio bearer (DRB), wherein the data is communicated using a plurality of data flows that are mapped to a single DRB, and wherein each of the plurality of data flows is configured to have a respective set of quality of service (QoS) characteristics specific to that data flow; receiving quality of experience (QoE) information to the base station based on the measurement of the at least one quality of experience (QoE) parameter; and performing an action to optimise QoS for the plurality of data flows mapped to a single DRB based on the received QoE information.

The action to optimise QoS for the plurality of data flows may comprise at least one of: adjusting a QoS requirement for at least one of the data flows mapped to the single DRB; optimising resources allocated for at least one of the data flows mapped to the single DRB; controlling a flow of data for at least one of the data flows mapped to the single DRB relative to at least one other of the data flows mapped to the single DRB; remapping at least one of the plurality of data flows to a different DRB; and transmitting information, for at least one data flow for which a QoE has fallen below a satisfactory level, to a core network to allow a core network function to optimise QoS parameters for that data flow.

The method may further comprise acquiring the result of at least one QoS measurement for at least one of the plurality of data flows mapped to the single DRB. The action to optimise QoS for the plurality of data flows may be based on the acquired result of at least one QoS measurement.

The result of at least one QoS measurement may be acquired by performing the measurement at the base station. The result of at least one QoS measurement may be acquired by receiving the result from the UE.

The action may comprise controlling the flow of data for at least one of the data flows relative to at least one other of the data flows by buffering data packets for at least one of the data flows.

Each set of QoS characteristics may be associated with a respective QoS class (e.g. represented by a quality class identifier (QCI/5QI)).

Each of the plurality of data flows may be associated with a respective set of QoS parameters comprising a quality class identifier (QCI/5QI) representing the set of QoS characteristics for that data flow and may additionally comprise at least one of: an Allocation and Retention Priority (ARP); a Guaranteed Flow Bit Rate (GFBR) parameter for at least one of uplink (UL) and downlink (DL); a Maximum Flow Bit Rate (MFBR) parameter for at least one of UL and DL; a notification control parameter; and a Reflective QoS Attribute (RQA) parameter.

At least one of the plurality of data flows mapped to the single DRB may be a guaranteed bit rate (GBR) data flow and at least one of the plurality of data flows mapped to the single DRB may be a non-GBR data flow. Each of a plurality of said data flows mapped to the single DRB may be a guaranteed bit rate (GBR) data flow.

Each of a plurality of said data flows mapped to the single DRB may be a non-guaranteed bit rate (non-GBR) data flow.

Various other modifications will be apparent to those skilled in the art and will not be described in further detail here.

This application is based upon and claims the benefit of priority from United Kingdom Patent Application No. 1715920.3, filed on Sep. 29, 2017, the disclosure of which are incorporated herein in their entirety by reference.

1. A method performed by a user equipment in a communication system, the method comprising:
communicating data with a base station using at least one data radio bearer (DRB), wherein the data is communicated using a plurality of data flows that are mapped to a single DRB, and wherein each of the plurality of data flows is configured to have a respective set of quality of service (QoS) characteristics specific to that data flow;
measuring at least one quality of experience (QoE) parameter for the plurality of data flows; and
reporting QoE information to the base station based on the measurement of the at least one QoE parameter.

2. A method as claimed in claim 1 wherein said measuring comprises respectively measuring the at least one QoE parameter for each of the plurality of data flows mapped to the single DRB.

3. A method as claimed in claim 1, wherein the reported QoE information comprises data flow specific QoE information for at least one of the plurality of data flows that are mapped to the single DRB, and wherein the reporting comprises reporting the data flow specific QoE information in association with information identifying the data flow (e.g. a QoS flow identifier, QFI) to which the data flow specific QoE information relates.

4. A method as claimed in claim 1, further comprising determining whether or not QoE has fallen below a satisfactory level for at least one data flow.

5. A method as claimed in claim 4 wherein the reported QoE information comprises at least one information element for indicating whether or not QoE has fallen below a satisfactory level for at least one data flow (e.g. at least one QoE flag).

6. A method as claimed in claim 5 wherein the at least one information element for indicating whether or not QoE has fallen below a satisfactory level comprises a respective said information element for each data flow for which QoE has fallen below a satisfactory level.

7. A method as claimed in claim 5 wherein the at least one information element for indicating whether or not QoE has fallen below a satisfactory level comprises a respective said information element for every data flow mapped to the single DRB.

8. A method as claimed in claim 1, wherein the reported QoE information comprises results acquired by the measuring of the at least one QoE parameter.

9. A method as claimed in claim 8 wherein the reported results acquired by the measuring of the at least one QoE parameter comprise respective said results for each data flow for which QoE has fallen below a satisfactory level.

10. A method as claimed in claim 8 wherein reported results acquired by the measuring of the at least one QoE parameter comprise respective said results for every data flow mapped to the single DRB.

11. A method as claimed in claim 1, further comprising measuring at least one QoS parameter for at least one of the plurality of data flows mapped to the single DRB.

12. A method as claimed in claim 11 wherein said reporting further comprises reporting QoS information to the base station based on the measurement of the at least one QoS parameter.

13. A method performed by a base station in a communication system, the method comprising:
communicating data with a user equipment (UE) using at least one data radio bearer (DRB), wherein the data is communicated using a plurality of data flows that are mapped to a single DRB, and wherein each of the plurality of data flows is configured to have a respective set of quality of service (QoS) characteristics specific to that data flow;
receiving quality of experience (QoE) information to the base station based on the measurement of the at least one quality of experience (QoE) parameter; and
performing an action to optimise QoS for the plurality of data flows mapped to a single DRB based on the received QoE information.

14. A method as claimed in claim 13 wherein the action to optimise QoS for the plurality of data flows comprises at least one of:
adjusting a QoS requirement for at least one of the data flows mapped to the single DRB;
optimising resources allocated for at least one of the data flows mapped to the single DRB;
controlling a flow of data for at least one of the data flows mapped to the single DRB relative to at least one other of the data flows mapped to the single DRB;
remapping at least one of the plurality of data flows to a different DRB; and
transmitting information, for at least one data flow for which a QoE has fallen below a satisfactory level, to a core network to allow a core network function to optimise QoS parameters for that data flow.

15. A method as claimed in claim 13 further comprising acquiring the result of at least one QoS measurement for at least one of the plurality of data flows mapped to the single DRB, wherein the action to optimise QoS for the plurality of data flows is based on the acquired result of at least one QoS measurement.

16. A method as claimed in claim 15 wherein the result of at least one QoS measurement is acquired by performing the measurement at the base station.

17. A method as claimed in claim 15 wherein the result of at least one QoS measurement is acquired by receiving the result from the UE.

18. A method as claimed in claim 13 wherein the action comprises controlling the flow of data for at least one of the data flows relative to at least one other of the data flows by buffering data packets for at least one of the data flows.

19. A method as claimed in claim 13 wherein each set of QoS characteristics is associated with a respective QoS class (e.g. represented by a quality class identifier (QCI/5QI)).

20. A method as claimed in claim 13 wherein each of the plurality of data flows is associated with a respective set of QoS parameters comprising a quality class identifier (QCI/5QI) representing the set of QoS characteristics for that data flow and at least one of: an Allocation and Retention Priority (ARP); a Guaranteed Flow Bit Rate (GFBR) parameter for at least one of uplink (UL) and downlink (DL); a Maximum Flow Bit Rate (MFBR) parameter for at least one of UL and DL; a notification control parameter; and a Reflective QoS Attribute (RQA) parameter.

21. A method as claimed in claim 13 wherein at least one of the plurality of data flows mapped to the single DRB is a guaranteed bit rate (GBR) data flow and at least one of the plurality of data flows mapped to the single DRB is a non-GBR data flow.

22. A method as claimed in claim 13 wherein each of a plurality of said data flows mapped to the single DRB is a guaranteed bit rate (GBR) data flow.

23. A method as claimed in claim 13 wherein each of a plurality of said data flows mapped to the single DRB is a non-guaranteed bit rate (non-GBR) data flow.

24. A method performed by a core network function in a communication system, the method comprising:
maintaining quality of service (QoS) information related to a communication session for a user equipment (UE), wherein the communication session is a communication session in which data is communicated via at least one data radio bearer (DRB) between the UE and a base station and using a plurality of data flows that are mapped to a single DRB, and wherein the maintained QoS information respectively comprises, for each data flow mapped to the single DRB, information representing a set of quality of service (QoS) characteristics specific to that data flow;
receiving quality of service (QoS) information provided by the base station for at least one data flow for which a QoE experienced at the UE has fallen below a satisfactory level; and
performing an action to optimise the maintained QoS information based on the received QoS information.

25. (canceled)

26. A user equipment (UE) for a communication system, the UE comprising:
at least one processor and transceiver, wherein the at least one processor is configured to:
control the transceiver to communicate data with a base station using at least one data radio bearer (DRB), wherein the data is communicated using a plurality of data flows that are mapped to a single DRB, and wherein each of the plurality of data flows is configured to have a respective set of quality of service (QoS) characteristics specific to that data flow;
measure at least one quality of experience (QoE) parameter for the plurality of data flows; and
control the transceiver to report QoE information to the base station based on the measurement of the at least one QoE parameter.

27. A base station for a communication system, the base station comprising:
at least one processor and transceiver, wherein the at least one processor is configured to:
control the transceiver to communicate data with a user equipment (UE) using at least one data radio bearer (DRB), wherein the data is communicated using a plurality of data flows that are mapped to a single DRB, and wherein each of the plurality of data flows is configured to have a respective set of quality of service (QoS) characteristics specific to that data flow;
control the transceiver to receive quality of experience (QoE) information to the base station based on the measurement of the at least one quality of experience (QoE) parameter; and
perform an action to optimise QoS for the plurality of data flows mapped to a single DRB based on the received QoE information.

28. A core network function for a communication system, the core network function comprising:
at least one processor and transceiver, wherein the at least one processor is configured to:
maintain quality of service (QoS) information related to a communication session for a user equipment (UE), wherein the communication session is a communication session in which data is communicated via at least one data radio bearer (DRB) between the UE and a base station and using a plurality of data flows that are mapped to a single DRB, and wherein the maintained QoS information respectively comprises, for each data flow mapped to the single DRB, information representing a set of quality of service (QoS) characteristics specific to that data flow;
control the transceiver to receive quality of service (QoS) information provided by the base station for at least one data flow for which a QoE experienced at the UE has fallen below a satisfactory level; and
perform an action to optimise the maintained QoS information based on the received QoS information.

29-30. (canceled)
